(19) United States
(12) Patent Application Publication
(10) Pub. No.: US 2003/0018699 A1
(43) Pub. Date: Jan. 23, 2003

(54) Automatic program deployment in a distributed system

(75) Inventors: Daniel J. Matthews, Southampton (GB); David Pitcher, Winchester (GB)

Correspondence Address: IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/044,729

(22) Filed: Jan. 11, 2002

(30) Foreign Application Priority Data
Jul. 18, 2001 (GB) 0117464.8

(51) Int. Cl. G06F 15/16; G06F 9/44; G06F 15/177

(52) U.S. Cl. 709/201; 709/203; 717/124; 709/221

(57) ABSTRACT

A process is defined which maintains in a host repository, such as a flat file or a database, a record of configuration information for a plurality of data processing hosts in a distributed system, such as a test system. Configuration information comprises details of products installed on the host and details of how such installed products are configured. Program requirements which contain the host configuration requirements of a program, such as a test program, to be executed are then obtained and compared with the host information in the host repository in order to identify a host that is capable of executing the program. One of these hosts is then selected and the program is executed on it.

### FIELD OF THE INVENTION

This invention relates to the deployment of programs in a distributed system and in particular to automatic deployment of programs in a test system.

### BACKGROUND OF THE INVENTION

Following the modern trend for complex distributed products and their development using object oriented techniques, new challenges face system test organisations that test such products prior to availability to customers.

Distributed products are designed to function in client/server processes which are distributed across many host machines in a distributed data processing system, potentially involving thousands of client/server processes on thousands of host machines. A suitable test system must therefore, to simulate a customer environment, include many client/server processes on many host machines. Many host machines in the test system are set up with the product under test and tested with many different customer like configurations. Further, the product under test may require certain other products in order to function and may also provide support for other optional products in order to provide different customers with different functionality. As a result host machines in the test system must also be set up and configured with the required products and variously set up and configured with some or none of the optional products. Further the product under test may require or support more than one release level of other products and each time the product under test changes release level, the level of the products that it requires or supports may change. All of this leads to a potentially very complex and rapidly changing test system that must be maintained by the test organisation.

Further, use of object oriented techniques allows more rapid development of new and updated products than was previously possible. This is due to several factors such as greater isolation of function, enabling increased reuse of existing code, and better tools to support development. As a result new and updated products can be developed in relatively small development cycles. This makes the above problem of maintenance of a test system even more of a burden.

An example of such a product is IBM's WebSphere Application Server Advanced Edition (WebSphere AS/AE) which provides support for Enterprise JavaBeans (EJB). WebSphere AS/AE supports several operating systems such as Windows NT, AIX and Solaris. (WebSphere is a registered trademark of IBM Corporation. Java, JavaBeans, EJB and Solaris are registered trademarks of Sun Microsystems Inc. Windows NT is a registered trademark of Microsoft Corporation.). Depending on the operating system it may require, for example IBM's DCE, and may optionally support, for example, database products such as IBM's DB2, or Oracle or Informix. These lists are by no means exhaustive but give a flavour of the many different possible configurations and environments the product must be tested in. Also because of the distributed nature of the product these environments can also communicate with each other and as a result this must also be tested.

Another aspect of the test of a product is the potentially large number of tests that must be created to test different aspects of the product under test. For example one test, which comprises a single test program, might test EJB entity bean support with DB2. In order to run this program the test system must include a host machine with DB2 installed and a server process of the product under test configured with support for DB2. This test may need to be run on Windows NT, AIX and Solaris. A large number of variations of such a test are possible involving any number of EJB's (entity and session beans), backed by different databases, and deployed on different operating systems. Further test programs can be discussed in gradually more detail, for example where the transaction under which the EJB's are accessed is started and what transaction timeout value to use. This makes the number of different combinations of test programs extremely large, many requiring a particular configuration of the product under test and use of a particular optional product.

Note also that such a test, in a client/server environment, may comprise a client program which communicates with one or more server programs. In this case it may be required to execute the client program on a host machine with one set of requirements and the server program on a different host machine with a different set of requirements, thus adding further complexity to the test.

As a result not only does the test system need to be maintained but the set up of host machines within the test system must be coordinated with the particular suite of test programs that are under test at different points in the test cycle. This can also lead to a problem with a complex test case, involving several different configurations, of finding the correct host machines in the test system on which to deploy it.

It can therefore be seen that the test organisation has a very complex and potentially time consuming task of setting up and maintaining a test system according to test program requirements. In addition, as the test system is likely to involve a relatively few number of host machines when compared to a customer, the set up of any host machine in the test system is likely to need to change during a product test cycle.

It can also be seen that whilst this problem is discussed in terms of a test system, it could also apply to a production system. A test program is basically a customer like program that is run on the product under test and performs similar functions to a customer program. Whilst a production system is unlikely to run programs that cover as many configurations of the product under test as required in test, the production system is likely to include more that one release of a product of the type that is under test in a test system.

### SUMMARY OF THE INVENTION

The present invention reduces the burden of tracking configurations of host machines in a distributed data processing system and deployment of programs to suitable data processing hosts within the distributed data processing system.

Accordingly, according to a first aspect the present invention provides a data processing method for running on a data processing host in a data processing system, the data processing system comprising a plurality of data processing hosts, the method comprising the steps of: maintaining a host information repository comprising host information for each of two or more of the plurality of data processing hosts, the host information comprising details relating to host configuration; obtaining program requirements comprising details relating to host configuration required for executing a program; identifying from the host information repository according to the obtained program requirements one or more data processing hosts capable of executing the program; and causing execution of the program on one of the one or more data processing hosts identified as capable of executing the program.

According to a second aspect the present invention provides a computer program comprising instructions which, when executed on a data processing host, causes said host to carry out a method of the first aspect.

According to a third aspect the present invention provides a data processing system comprising a plurality of data processing hosts wherein at least one data processing host comprises: maintaining means for maintaining a host information repository comprising host information for each of two or more of the plurality of data processing hosts, the host information comprising details relating to host configuration; obtaining means for obtaining program requirements comprising details relating to host configuration required for executing a program; host identifying means for identifying from the host information repository according to the obtained program requirements one or more data processing hosts capable of executing the program; and execution means for causing execution of the program on one of the one or more data processing hosts identified as capable of executing the program.

The present invention therefore defines a process which maintains in a host repository, such as a flat file or a database, a record of configuration information for a plurality of data processing hosts in a distributed system, such as a test system. Configuration information comprises details of products installed on the host and details of how such installed products are configured. For example configuration information could include details of a database product installed and details of databases configured for that database product. The program requirements which contain the host configuration requirements of a program, such as a test program, to be executed are then obtained and compared with the host information in the host repository in order to identify a host that is capable of executing the program. For example, if a program requires the AIX operating system and DB2 installed and configured with a database of name Policy, one or more hosts are found that satisfy these requirements. One of these hosts is then selected and the program is executed on it.

In a system, such as a test system, where host machine configurations and the requirement of programs can change regularly, this reduces greatly the burden of system administration and test program deployment.

Preferably host information for a host is received in a message sent by the host. Alternatively the host information could be written to, for example, a common database by each host.

Optionally the host information also comprises details relating to host state, such a CPU usage, disk space, number of databases etc. This enables programs to be targeted to host machines according to more dynamic requirements. For example a crucial CPU hungry program could require a host to be running at less that 20% CPU usage in order to execute satisfactorily. This is possible in an example in which details of host state comprise CPU usage.

Preferably the program requirements may also specify configuration requirements of one or more hosts which the program, in execution, needs to communicate with. If this is the case, further to identifying a data processing host on which to execute the program, suitable hosts for the program to communicate with can be identified, and given to the program for use during execution. This enables program requirements of a client program to specify additional host configurations which, for example, include details of server programs that it needs to communicate with, and provides a method for the program to be informed of the location of the suitable server programs. Note that a server program can run as a server process or as part of a server process which is capable of running more than one server program.

Preferably a program repository is defined which contains program requirements for a plurality of programs, and method is provided for receiving a program execution policy comprising a subset of program requirements. The program repository may then be searched to identify one or more programs with the requirements specified in the program execution policy. For example a program execution policy could specify DB2 databases named “account” and “claim” and all programs that require both of these databases will then be identified. Each program identified is then executed on a suitable host identified from the host repository. This is particularly useful in a test environment as it enables a particular set of test programs to be executed thus targeting a particular aspect of the product under test to be tested.

Alternatively a method is provided for receiving a host execution policy comprising a subset of host information. This specifies a particular host or group of hosts on which programs should be run. For example a host execution policy could specify the AIX operating system meaning that all programs that require AIX should, if possible, be run on suitable hosts. From the host execution policy a list of suitable hosts are identified, and from this a list of programs that are capable of running on the identified hosts are identified. The identified programs are then executed on the identified hosts. Further if the host information also comprises state information the host execution policy can also specify state. For example a host execution policy could specify a CPU usage wherein test programs are continually executed on the identified hosts whilst the CPU usage is below the specified minimum. This is particularly useful in a test environment as it enables stress testing to be easily performed.

Preferably program requirements can also specify one or more other required programs. This enables a program to specify one or more other program to be run, potentially on a different hosts, thus enabling programs to be run concurrently such that they are able to communicate.

Preferably the program that is executed is a test program that is designed to test a product that is installed on one or more data processing hosts.

### BRIEF DESCRIPTION OF THE DRAWINGS

The invention will now be described, by way of example only, with reference to a preferred embodiment thereof, as illustrated in the accompanying drawings, in which:

FIG. 1 is a block diagram of data processing environment in which the preferred embodiment of the present invention is advantageously applied;

FIG. 2 is a schematic diagram of receiving host information from a plurality of hosts and maintaining that information in a database according to the preferred embodiment of the present invention;

FIG. 3 is a representation of how host information is stored in a searchable form according to the preferred embodiment of the present invention;

FIG. 4 is a schematic diagram of receiving host information from a plurality of hosts, maintaining host information in a database, comparing program requirements with host information and executing programs on an identified host according to the preferred embodiment of the present invention;

FIG. 5 is a flow chart of the processing of a snoop coordinator according to the preferred embodiment of the present invention;

FIGS. 6a. and 6b. constitute a flow chart of the processing of a policy coordinator according to the preferred embodiment of the present invention; and

FIG. 7 is a flow chart of the processing of an executor according to the preferred embodiment of the present invention;

Note that in the figures, where a like part is included in more than one figure, where appropriate it is given the same reference number in each figure.

### DESCRIPTION OF THE PREFERRED EMBODIMENT

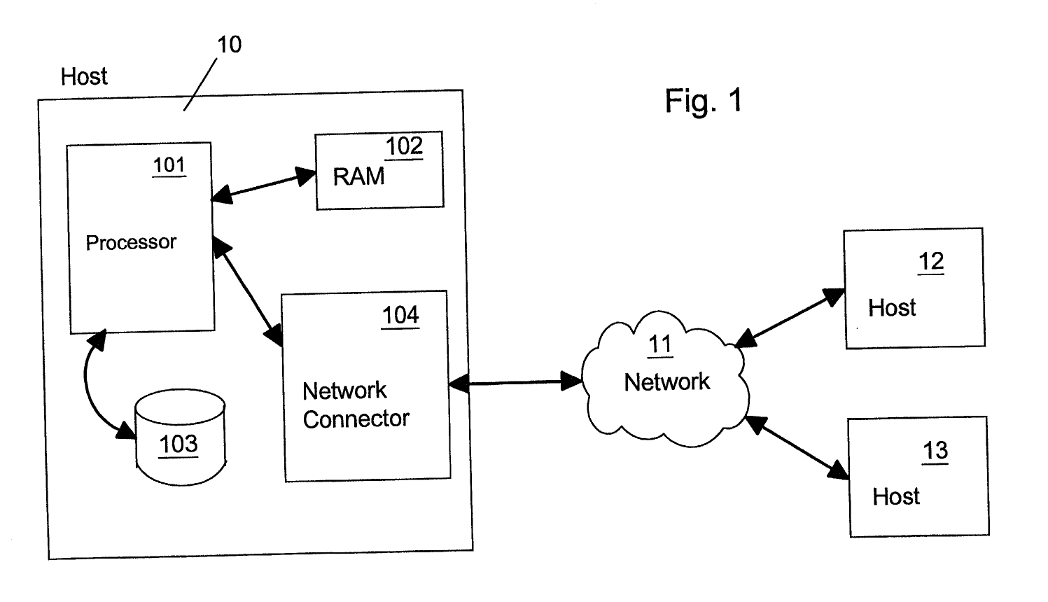

In FIG. 1, a data processing host apparatus 10 is connected to other data processing host apparatuses 12 and 13 via a network 11, which could be, for example, the Internet. The hosts 10, 12 and 13 constitute a test system and interact with each other, in the preferred embodiment, to carry out the tracking of server configurations and the execution of test programs. Although three hosts are shown, the test system could contain any number of similar hosts. Host 10 has a processor 101 for controlling the operation of the host 10, a RAM volatile memory element 102, a non-volatile memory 103, and a network connector 104 for use in interfacing the host 10 with the network 11 to enable the hosts to communicate.

The preferred embodiment of the present invention includes a process, installed on a plurality of host machines, which sends host information for the host machine on which it is installed to a central point. The host information comprises configuration information and state information. The central point consolidates the information it receives from each host into a searchable host repository. Stored in a separate searchable testcase repository (program repository) is a list of test programs with execution details for each program and the program executable. The execution details comprise configuration requirements of one or more host configurations required to execute the program. Note that a program can require more than one host configuration if, for example, it is a client program that communicates with one or more server programs and the client program has different host configuration requirements compared to the server program(s). Now, when a test program is to be run, its execution details are read from the testcase repository and used to find hosts from the host database that can satisfy each of the host requirements specified in the execution details. If the search provides more than one suitable host for a particular configuration requirement an algorithm can be provided to reduce the selection to one. Once a host is selected to execute the program on, the program is sent to that host and executed. If the program requires several host configurations, this may require passing details of host(s) selected to the program, for example a client program may be passed details of the host machine(s) on which the server program(s) it is to communicate with resides. These and other details of the preferred embodiment will now be discussed in more detail.

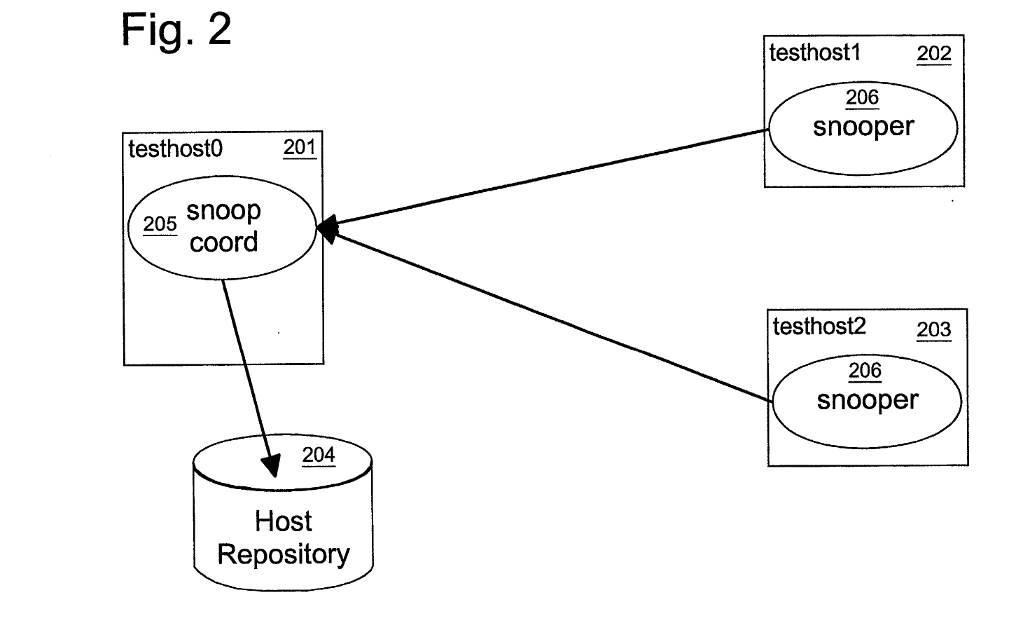

The first part of the preferred embodiment is to define a host process and a central point. The host process obtains configuration and state information of a host machine and sends it to the central point which maintains such information for a plurality of hosts. In the preferred embodiment the host process is termed a snooper and the central point is termed the snoop coordinator. This is shown in FIG. 2 in which a test system comprising three host machines is shown. testhost0 (201) is installed with a snoop coordinator, and testhost1 (202) and testhost2 (203) are each installed with a snooper (206). Each snooper (206) obtains configuration and state information about the machine it is running on. Configuration information in the preferred embodiment, comprises: DB2 level and configured tables; “productA” servers and configured applications; operating system type, level, and cpu usage; and program languages available. There are various ways that a snooper can obtain this type of information. For example on NT it can look in the system registry and on AIX it can obtain information from the system management interfaces. Also a snooper can be programmed with knowledge of how to, for example, ask DB2 and the product under test for details of their configurations and the operating system for its cpu usage. Once obtained this information is sent in a message to the snoop coordinator. Once the information has been sent for the first time, changes in the information are sent periodically although in other embodiments the policy for sending updated information may be different.

Note that the configuration and state information used in the preferred embodiment are just examples of the type of information that might be used under the present invention. Further, in practice the configuration information is likely to be much more extensive compared to the relatively few configuration details used in this description. With a correctly programmed snooper details of the presence and configuration and state of all products required for a set of test programs can be sent to a snoop coordinator.

Testhost0 (201) is installed with a snoop coordinator (205). The snoop coordinator (205) accepts messages, containing configuration and state information, from the snoopers (206). The snoop coordinator (205) stores this information in a host repository (204) thus providing a consolidated view of configuration and state information for all machines in the test system. The host repository is stored in a database on a data server. Note that, in FIG. 2, the snoop coordinator (205) is shown on a different host to the snoopers (206) but in practice a snoop coordinator can be on the same machine as a snooper. Further more than one snoop coordinator can exist where either they all share the same host repository or each has a different host repository and maintains host and state information for a subset of the host machines. Also the test suite shown comprises 3 host machines but in practice this is not limited to any particular number.

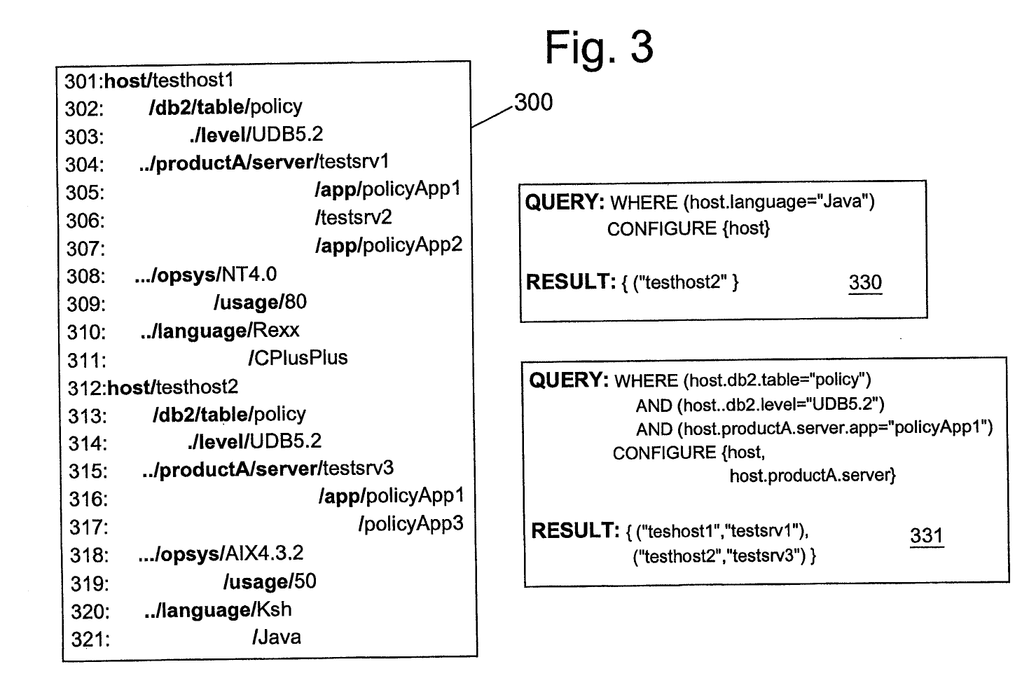

FIG. 3 shows a representation of how, in the preferred embodiment of the present invention, information in the host repository is stored and queried. The information is set up in a tree structure (300) that can be easily queried. Note that in the tree structure (300) shown in FIG. 3 a reference numeral is used for each line. The structure (300) contains an entry (301) for testhost1 (202 of FIG. 2) and an entry (312) for testhost2 (203 of FIG. 2). Information is stored for each host relating to: DB2 level and configured tables; “productA” server processes and their configured server programs; operating system type, level, and cpu usage; and program languages available. As a result FIG. 3 contains information which shows that testhost1 has: DB2 UDB5.2 (303) installed and set up with table “policy” (302); two “productA” server processes, tesrsv1 (304) which is configured for server program “policyApp1” (305), and testsrv2 (306) which is configured for server program “policyApp2”; operating system NT4.0 (308) installed and currently running at 80% CPU usage (309); and capability to execute programs written in the languages Rexx (310) and C++ (311). Similarly testshost2 has: DB2 UDB5.2 (314) installed and set up with table “policy” (313); a “productA” server process, testsrv3 (315), which is configured for server programs “policyApp1” (316) and “policyApp3” (317); operating system AIX 4.3.2(318) installed and currently running at 50% CPU usage (319); and capability to execute programs written in the languages Ksh (Korn Shell) (320) and Java (321).

FIG. 3 also shows examples of two queries and their results (330, 331) according to the preferred embodiment of the present invention. Each query shows the requirements of the query after the WHERE keyword and the results required from the query after the CONFIGURE keyword. The first query (330) is to find hosts that can run a Java program. The result required from the query is the name of a suitable host. In this case the query is satisisfied by testhost2 (312) and its name is returned in the result from the query (330). Note that this query could be, for example, to find a host suitable for executing a client program that communicates with server programs on potentially different hosts.

The second query (331) is to find hosts that have DB2 level UDB5.2 installed and configured with a table named “policy”, and a “productA” server process configured for server program “policyApp1”. The results required from the query are the names of a host and an appropriate server process (i.e.: one configured for server program “policyApp1”). In this case the query is satisfied by both testhost1 (301) and testhost2 (312) with “productA” server processes testrv1 (304) and testrv3 (315), respectively. As a result the names for both hosts are returned in the result (332) from the query, which therefore contains two sets of results. Note that this query could be, for example, to find a suitable host and server for a client program to communicate with when using server program “policyApp1”.

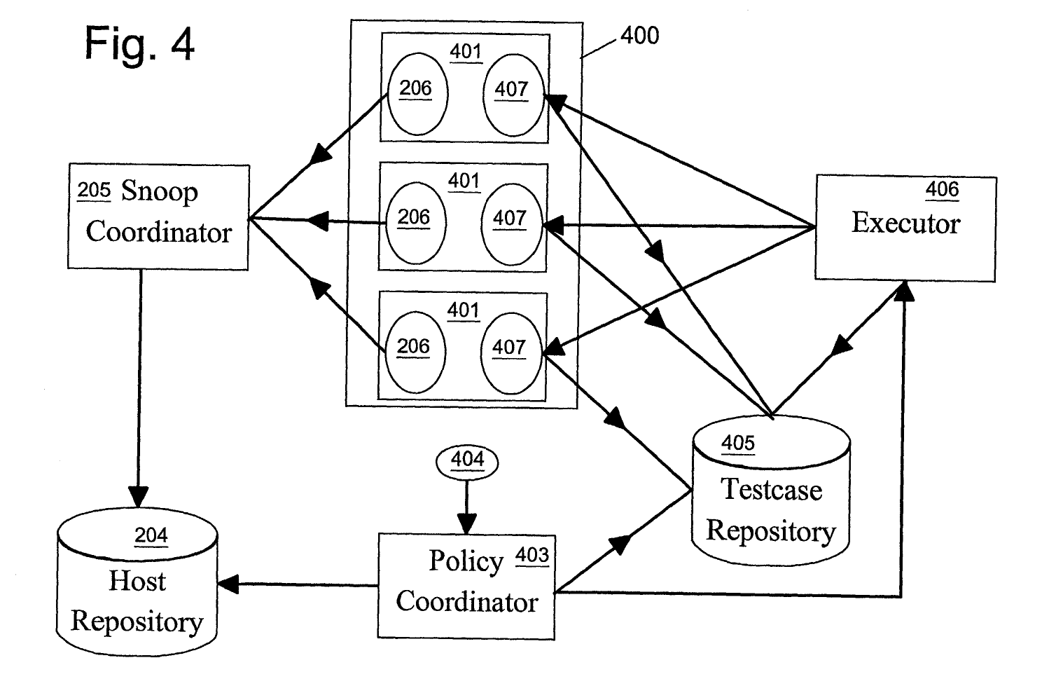

The next part of the preferred embodiment is to define processes for obtaining program details, matching them with one or more suitable hosts, and then executing them on a suitable host. This is illustrated in FIG. 4. which shows a group (400) of data processing hosts (401) each with an associated snooper (206). The snoopers each send messages, containing configuration and state information to the snoop coordinator (205) which maintains the information in a host repository (204). The policy coordinator (403) accepts requests from an outside agency (404), such as a user, to run one or more programs. A request could be for a specific program, for a program based execution policy or a host based execution policy, and may include some indication of when to run the program(s), such as a time delay or specific time.

A program based policy specifies one or more programs to run based on a common set of requirements, for example all programs that require DB2. As a result, for example and in consideration of FIG. 3, if in testing “productA” it is required to target tests at “productA” support of DB2, a program execution policy could be requested to run all programs that require use of server programs “policyApp1”, “policyApp2” and “policyApp3”.

A host based policy specifies a host configuration for which one or more programs must be found and executed, for example all programs that will run on a particular data processing host with product A installed and whilst its cpu usage is less than 95%. As a result, for example, if in testing “productA” it is required to stress test “productA” on testsrv1, a host execution policy could be requested to run all programs that use a “productA” server process and are capable of running on data processing host testhost1, where programs are executed on testhost1 whenever its CPU usage is less that 99%.

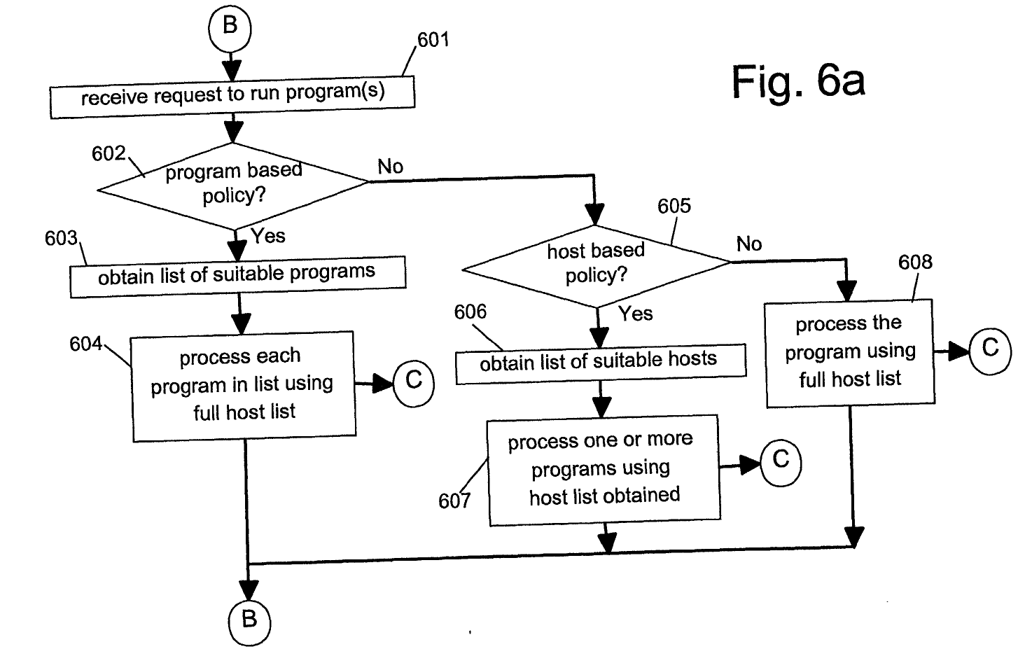

Whichever the type of request the policy coordinator (403) receives it reads information on programs from the testcase repository (405) and information on hosts from the host repository (204) and selects, for each program to be run, the host on which it is to be run. How the policy coordinator (403) does this will be discussed more fully with reference to FIGS. 6a and 6b. The policy coordinator (403) provides an Executor (406) with details of a program to be run and a host to run it on.

The Executor (406) uses this information, and possibly additional information obtained from the testcase repository (405), to execute the program on the specified host. This is done, in the preferred embodiment, by running a daemon process (407), which listens on a TCP/IP port, on each data processing host. The Executor (406) then sends a request to the daemon (407) of the specified host giving details of the program name, the time to execute it, the execution environment required for the program (e.g.: the language support it requires), and any parameters to be passed to the program. The daemon (407) then, if necessary, downloads the program executable from the testcase repository (405) before executing it at the time, in the environment, and by passing it the parameters, specified in the request from the Executor (405).

Note that in the preferred embodiment the program requirements stored in the testcase repository are maintained in a tree based searchable database as illustrated for the host repository in FIG. 3. As a result this does not require any further discussion.

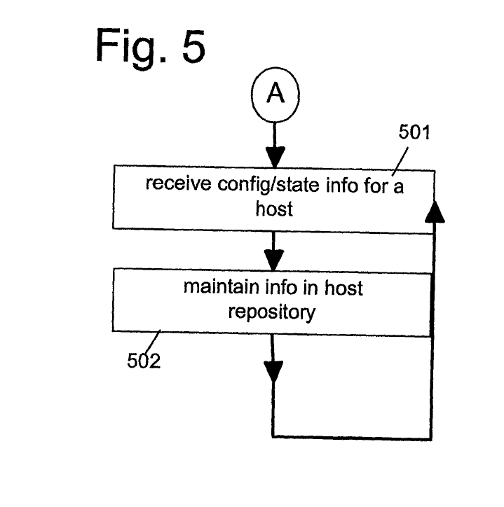

FIG. 5 shows the processing of the snoop coordinator (203 of FIG. 2). At step 501 it receives input from a snooper with details of host configuration and/or state for the data processing host on which the snooper is running. This could be a full set of information, or a subset of information relating to only changes in information, on the data processing host. At step 502 the snoop coordinator writes the information received into a database. The information is written in a searchable form such as the structure illustrated in FIG. 3. This may involve writing new information or updating existing information. The process then repeats as the snoop coordinator receives more information from the same or other snoopers.

FIGS. 6a and 6b show the processing of the policy coordinator (403 of FIG. 4) and executor (405 of FIG. 5). At step 601 in FIG. 6a, a request is received to run one more programs. At step 602 a check is made to see if a program based execution policy has been requested. If so, at step 603 a list of programs, that have the same requirements as specified in the policy, is obtained from the testcase repository (404 of FIG. 4). Step 604 then processes each program in the list with method C and using a full list of hosts (method C will be described subsequently with reference to FIG. 6b). The method completes when all programs in the list have been processed.

If a program based policy was not specified processing proceeds from step 602 to step 605 where a check is made to see if a host based execution policy has been requested. If so a list of one or more data processing hosts that have the configuration and/or state as specified in the policy is obtained from the host repository (204 of FIG. 2). Having obtained the host list, step 606 processes one or more programs obtained from the testcase repository (405 of FIG. 4), with method C and using the obtained host list. How many programs are processed in this way is optional and may depend on the host based execution policy. The method completes when all selected programs have been processed.

If a host based policy was not specified processing an individual program must have been specified and processing progresses from step 605 to step 608. A step 608 the specified program is processed with method C and using a full list of hosts. The method completes when the program has been processed.

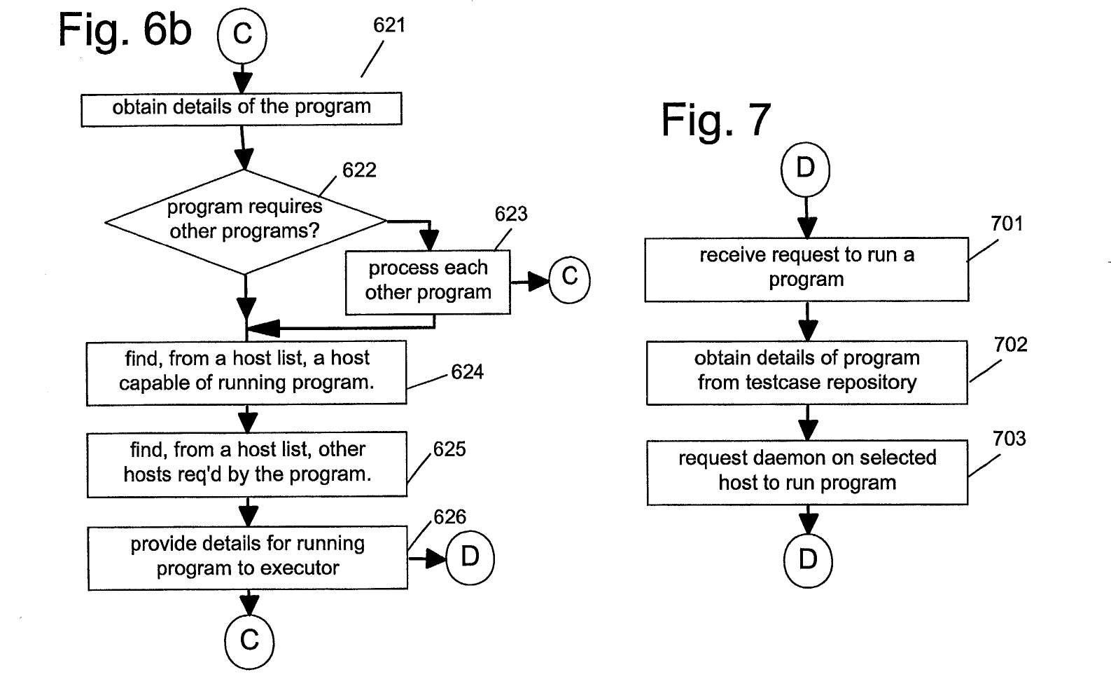

FIG. 6b shows the processing of method C which is used to process a specified program. Note that step 624 of this method uses a host list as specified in the step that called method C. This could be any of steps 604,607 and 608 in FIG. 6a. At step 621 details of the program are read from the program repository. These details include the data processing host configuration required to run the program, possibly configuration requirements of other hosts required by the program, and possibly details of other programs that must be executed at the same time as it. At step 622 a check is made to see if the program requires other programs to be run at the same time. If it does method C is invoked for each required program at step 623. Note that the invocation of method C from step 623 (and therefore from within method C) uses the host list specified in the step that originally called method C. If the program specified does not require other programs, at step 624 the host repository is searched for a suitable data processing host on which to run the program. This search is based on a host list as specified by the step that called method C and could be all hosts in the host repository or, if a host based policy is being processed, a subset of hosts in the host repository. Note that if more than one suitable host is found a further algorithm may be used in order to select a particular host (e.g.: round robin, least busy etc.). At step 625 any additional hosts required by the program are found from the host list used in the previous step (624). Additional hosts may be required, for example, if the program is a client program that requires use of server programs. Finally at step 625 a request is sent to method D of the executor process to run the program (method D will be described subsequently with reference to FIG. 7). In the preferred embodiment the request includes the program name, the time to run the program, the executable environment required by the program and the parameters to pass to the program. If the program is a client program the parameters, could be, for example, the details of server processes to communicate with in operation.

FIG. 7 illustrates the processing of method D in the executor. At step 701 the executor receives a request, from method C step 626, to run a program on a specified host. At step 702 any extra details required to run the program can be obtained from the testcase repository, although the request received at step 701 may include all information required. At step 703 a request to run the program is sent to the daemon process of the specified host. The request includes the program name, the time to run the program, the executable environment required by the program and the parameters to pass to the program.

Thus the preferred embodiment of the present invention provides a test system in which data processing host configurations are automatically tracked and maintained in a central host repository. Further configuration requirements of test programs are stored in a testcase repository. A policy coordinator receives requests to run one or more programs, obtains the requirements for the programs from the testcase repository and matches them with hosts based on the host configuration stored in the host repository. Once a suitable host for executing the program has been identified the test program is executed on it. If a program requires use of server programs its requirements can also include details of host configuration that support the required server programs. Whilst this has been described, in the preferred embodiment, for a test system the invention could also be applied to a production system.

Further the configuration and state information used in the preferred embodiment are simply examples. Configuration information can include product details, such as name and level, and configuration details for those products. Configuration details for a product can be any configuration details externally available through, for example, commands or programming interfaces. State information can include any state details also made available by a product through commands or programming interfaces. For example CPU usage, number of active connections. log size etc.

1. A data processing method for running on a data processing host in a data processing system, the data processing system comprising a plurality of data processing hosts, the method comprising the steps of:
maintaining a host information repository comprising host information for each of two or more of the plurality of data processing hosts, the host information comprising details relating to host configuration;
obtaining program requirements comprising details relating to host configuration required for executing a program;
identifying from the host information repository according to the obtained program requirements one or more data processing hosts capable of executing the program; and
causing execution of the program on one of the one or more data processing hosts identified as capable of executing the program.

2. A method as claimed in claim 1 further comprising the step of:
receiving the host information for a data processing host in a message sent from the data processing host.

3. A method as claimed in claim 1 wherein the host information further comprises details relating to host state.

4. A method as claimed in claim 1 wherein:
the program requirements further comprise details relating to one or more host configurations required for the program to communicate with;
the identifying step further identifying one or more data processing hosts suitable for the program to communicate with; and
the causing step further making the program aware of one or more data processing hosts suitable for it to communicate with.

5. A method as claimed in claim 1 further comprising the steps of:
receiving a program execution policy comprising a subset of program requirements;
identifying from a program repository comprising program requirements for a plurality of programs one or more programs with program requirements which comprise the program execution policy; and
repeating the obtaining, identifying one or more data processing hosts capable of executing the program, and causing steps for each of the one or more programs with program requirements which comprise the program execution policy.

6. A method as claimed in claim 1 further comprising the steps of:
receiving a host execution policy comprising a subset of host information;
identifying from the host repository one or more data processing hosts with host information which comprises the host execution policy; and
repeating the obtaining, identifying one or more data processing hosts capable of executing the program, and causing steps for a plurality of programs;
wherein the identifying one or more data processing hosts capable of executing the program step considers only the one or more data processing hosts with host information which comprises the host execution policy.

7. A method as claimed in claim 1 wherein program requirements further comprise one or more other programs and wherein the method further comprises the step of:
repeating the obtaining, identifying one or more data processing hosts capable of executing the program, and causing steps for each of the other programs identified in the program requirements.

8. A method as claimed in claim 1 wherein the program is for testing a product installed one or more of the plurality of data processing hosts.

9. A computer program product recorded on a computer readable medium, said program product comprising instructions which, when executed on a data processing host in a data processing system comprising a plurality of data processing hosts, cause said host to carry out a method comprising the steps of:
maintaining a host information repository comprising host information for each of two or more of the plurality of data processing hosts, the host information comprising details relating to host configuration;
obtaining program requirements comprising details relating to host configuration required for executing a program;
identifying from the host information repository according to the obtained program requirements one or more data processing hosts capable of executing the program; and
causing execution of the program on one of the one or more data processing hosts identified as capable of executing the program.

10. A computer program product as claimed in claim 9, wherein the method further comprises the step of:
receiving the host information for a data processing host in a message sent from the data processing host.

11. A computer program product as claimed in claim 9 wherein the host information maintained in the host information repository further comprises details relating to host state.

12. A computer program product as claimed in claim 9 wherein:
the program requirements further comprise details relating to one or more host configurations required for the program to communicate with;
the identifying step further identifying one or more data processing hosts suitable for the program to communicate with; and
the causing step further making the program aware of one or more data processing hosts suitable for it to communicate with.

13. A computer program product as claimed in claim 9, wherein the method further comprises the steps of:
receiving a program execution policy comprising a subset of program requirements;
identifying from a program repository comprising program requirements for a plurality of programs one or more programs with program requirements which comprise the program execution policy; and
repeating the obtaining, identifying one or more data processing hosts capable of executing the program, and causing steps for each of the one or more programs with program requirements which comprise the program execution policy.

14. A computer program product as claimed in claim 9, wherein the method further comprises the steps of:
receiving a host execution policy comprising a subset of host information;
identifying from the host repository one or more data processing hosts with host information which comprises the host execution policy; and
repeating the obtaining, identifying one or more data processing hosts capable of executing the program, and causing steps for a plurality of programs;
wherein the identifying one or more data processing hosts capable of executing the program step considers only the one or more data processing hosts with host information which comprises the host execution policy.

15. A computer program product as claimed in claim 9 wherein program requirements further comprise one or more other programs and wherein the method further comprises the step of:
repeating the obtaining, identifying one or more data processing hosts capable of executing the program, and causing steps for each of the other programs identified in the program requirements.

16. A computer program product as claimed in claim 9 wherein the program is for testing a product installed one or more of the plurality of data processing hosts.

17. A data processing system comprising a plurality of data processing hosts wherein at least one data processing host comprises:
maintaining means for maintaining a host information repository comprising host information for each of two or more of the plurality of data processing hosts, the host information comprising details relating to host configuration;
obtaining means for obtaining program requirements comprising details relating to host configuration required for executing a program;
host identifying means for identifying from the host information repository according to the obtained program requirements one or more data processing hosts capable of executing the program; and
execution means for causing execution of the program on one of the one or more data processing hosts identified as capable of executing the program.

18. A system as claimed in claim 17 further comprising:
means for receiving host information for a data processing hosts in a message sent from the data processing host.

19. A system as claimed in claim 17 wherein host information further comprises details relating to host state.

20. A system as claimed in claim 17 wherein:
program requirements further comprise details relating to one or more host configurations required for the program to communicate with;
the host identifying means is further operable to identify one or more data processing hosts suitable for the program to communicate with; and
the execution means is further operable to make the program aware of one or more data processing hosts suitable for it to communicate with.

21. A system as claimed in claim 17 further comprising:
means for receiving a program execution policy comprising a subset of program requirements; and
means for identifying from a program repository comprising program requirements for a plurality of programs one or more programs with program requirements which comprise the program execution policy;
wherein the obtaining means, host identifying means, and execution means are operable for each of the plurality of programs which comprise the program execution policy.

22. A system as claimed in claim 17 further comprising:
means for receiving a host execution policy comprising a subset of host information; and
means for identifying from the host repository one or more data processing hosts with host information which comprises the host execution policy;
wherein the obtaining means, host identifying means, and execution means are operable for a plurality of programs; and
wherein the host identifying means is operable to consider only the one or more data processing hosts with host information which comprises the host execution policy.

23. A system as claimed in claim 17 wherein program requirements further comprise one or more other programs and wherein obtaining means, host identifying means, and execution means are operable for each of the other programs identified in the program requirements.

24. A system as claimed in claim 17 wherein the program is for testing a product installed one or more of the plurality of data processing hosts.
